(19) United States
(12) Patent Application Publication
(10) Pub. No.: US 2026/0161317 A1
(43) Pub. Date: Jun. 11, 2026

(54) EFFICIENTLY HANDLING EXPIRED MESSAGES IN MIDDLEWARE OF MESSAGING SYSTEMS

(71) Applicant: INTERNATIONAL BUSINESS MACHINES CORPORATION, Armonk, NY (US)

(72) Inventors: Mark David COOPER, Poughkeepsie, NY (US); Cameron Thomas DOGGETT, Austin, TX (US); Mark Richard GAMBINO, Brewster, NY (US); James V. FARMER, Wappingers Falls, NY (US); John MULLER, Wappoingers Falls, NY (US); Leo GIANNELLI, Brooklyn, NY (US)

(21) Appl. No.: 18/973,302

(22) Filed: Dec. 9, 2024

(51) Int. Cl. G06F 3/06

(52) U.S. Cl. CPC G06F 3/0652; G06F 3/0604; G06F 3/0673

(57) ABSTRACT

A method includes: creating a bundle control file associated with a bundle that includes a group of messages stored in a persistent storage by a message-oriented middleware, wherein the bundle control file includes: respective pointers associated with respective ones of the messages in the bundle; respective expiration times associated with the respective ones of the messages in the bundle; and a last expiration time that equals a latest one of the respective expiration times; determining, based on reading the bundle control file from the persistent storage, that at least one of the messages in the bundle is expired; and removing, based on the determining, the at least one of the messages from the persistent storage.

### BACKGROUND

Aspects of the present invention relate generally to computer-based messaging systems and, more particularly, to handling expired messages in messaging middleware.

Messaging systems may include messaging middleware (also referred to message-oriented middleware (MOM)) that allows distributed applications to communicate and exchange data by sending and receiving messages. In such environments, applications may communicate by sending each other data in messages rather than by calling each other directly.

### SUMMARY

In a first aspect of the invention, there is a computer-implemented method including: creating a bundle control file associated with a bundle that includes a group of messages stored in a persistent storage by a message-oriented middleware, wherein the bundle control file comprises: respective pointers associated with respective ones of the messages in the bundle; respective expiration times associated with the respective ones of the messages in the bundle; and a last expiration time that equals a latest one of the respective expiration times; determining, based on reading the bundle control file from the persistent storage, that at least one of the messages in the bundle is expired; and removing, based on the determining, the at least one of the messages from the persistent storage.

In another aspect of the invention, there is a computer program product comprising one or more computer-readable storage media and program instructions stored on the one or more computer-readable storage media to perform operations comprising: creating a bundle control file associated with a bundle that includes a group of messages stored in a persistent storage by a message-oriented middleware, wherein the bundle control file comprises: respective pointers associated with respective ones of the messages in the bundle; respective expiration times associated with the respective ones of the messages in the bundle; and a last expiration time that equals a latest one of the respective expiration times; determining, based on reading the bundle control file from the persistent storage, that at least one of the messages in the bundle is expired; and removing, based on the determining, the at least one of the messages from the persistent storage.

In another aspect of the invention, there is a system including a processor set, one or more computer-readable storage media, and program instructions stored on the one or more computer-readable storage media to cause the processor set to perform operations comprising: creating a bundle control file associated with a bundle that includes a group of messages stored in a persistent storage by a message-oriented middleware, wherein the bundle control file comprises: respective pointers associated with respective ones of the messages in the bundle; respective expiration times associated with the respective ones of the messages in the bundle; and a last expiration time that equals a latest one of the respective expiration times; determining, based on reading the bundle control file from the persistent storage, that at least one of the messages in the bundle is expired; and removing, based on the determining, the at least one of the messages from the persistent storage.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows an example of a bundle and a bundle control file in accordance with aspects of the present invention.

FIG. 4 shows a flowchart of an exemplary method in accordance with aspects of the present invention.

FIG. 5 shows a flowchart of an exemplary method in accordance with aspects of the present invention.

FIG. 6 shows a flowchart of an exemplary method in accordance with aspects of the present invention.

FIG. 7 shows a flowchart of an exemplary method in accordance with aspects of the present invention.

### DETAILED DESCRIPTION

Aspects of the present invention relate generally to messaging systems and, more particularly, to handling expired messages in messaging middleware. In embodiments, messaging middleware stores copies of respective messages in persistent storage, such as disk storage, while awaiting an indication of receipt of the messages from a receiving node. According to aspects of the invention, the messaging middleware defines bundles of the messages stored in persistent storage and creates a respective bundle control file for each bundle. The bundle control file for a bundle includes respective pointers associated with respective ones of the messages in the bundle, respective expiration times associated with the respective ones of the messages in the bundle, and a last expiration time that equals a latest one of the respective expiration times of the messages in the bundle. In various embodiments, the messaging middleware determines the respective expiration times of all the messages in a bundle by performing a single input/output operation (referred to herein as an I/O) to the persistent storage to obtain the bundle control file for the bundle, rather than performing a respective I/O to the persistent storage for each respective one of the messages in the bundle. In this manner, implementations of the invention increase the efficiency of the messaging middleware by reducing the number of I/Os performed when determining the expiration times of messages stored in persistent storage.

Message queuing middleware, which is a type of messaging middleware or MOM, provides support for a message delivery model between interconnected nodes. An advantageous supported property for message queuing middleware is to guarantee delivery for persistent messages. If an application on one node sends a message to a second node, it is guaranteed to be delivered on the receiving node even if the receiving node resides across a communications network where failures may occur at the sending node, the receiving node, or the network. To achieve that end, the sending node keeps a copy of the first “N” number of queued messages in volatile memory (for performance reasons) and stores a copy of all queued messages to at least one persistent storage media, for example disk storage, such that the messages are still available if the server fails. After a system failure, to reconstruct the messages on a queue to their correct state prior to the system failure, log files containing transaction information may be used. Persistence is therefore guaranteed by saving messages to disk storage at the expense of the I/Os to write the messages to disk storage and the disk space used. When an application issues an application programming interface (API) command to put a persistent message on a queue, the system writes a copy of the message to the disk storage and waits for that I/O to complete before returning control to the application. In the case of an outage on the sending system, queues can be reconstructed by reading messages and logs saved to the disk storage into memory and then resuming queue activity. After a message has been sent and acknowledged as received by the remote system, the sending system can delete all copies of that message that reside in memory and on the disk storage. How and when the sending system deletes messages is implementation dependent as are the structures used to maintain a copy of messages in the disk storage.

Some messages, even persistent messages, are only useful for a certain amount of time, meaning if the message cannot be delivered to a user specified amount of time, the system should discard that message rather than try to deliver it later. For example, if a message is to inform the recipient that an airline flight is now leaving out of gate 13 instead of gate 2 and will depart in 30 minutes, if the message cannot be delivered in the next 30 minutes, then there is no point in delivering that message. When an application puts a message on a queue, it can optionally assign an expiration time for that message. On a given queue, different messages can have different expiration times, and some can have no expiration time. For example, if a sender specifies an expiration time of one minute for a message and the message remains on queue for longer than one minute, the system should not try to deliver that message anymore and instead should discard all copies of that message from memory and from the disk storage. How and when the system deletes expired messages is also implementation dependent. For example, some implementations remove an expired message from queue when that message becomes the first (e.g., oldest) message on queue, meaning it would be the message returned to the application that issues a “get message” API. Other implementations might periodically scan the queues for expired messages and delete them proactively. For example, the queue manager could scan queues every few minutes (e.g., five minutes), reading all messages to discover and then discard the expired messages. If such a time-initiated utility ran too often for large queues, performance problems can result due to the large number of I/Os to the disk storage needed to scan all the messages on the queue. If few or no expired messages are found, all that I/O processing to read all the messages on the disk storage is overhead with little to no value. However, not running such a utility often enough could leave many expired messages left unnecessarily on the disk storage resulting in running out of disk storage. Another problem is that if an application issues a “get message” API and the first several thousand messages on queue have all expired, then there will be significant overhead in I/Os performed for reading (and deleting) all those expired messages from disk storage until the system finds a message that is not expired, which can result in costly delays that prevent applications from achieving time-related service level agreements (SLAs) because a “get message” API that typically completes in microseconds is now taking hundreds of milliseconds.

System recovery has the same problem if an outage occurs when almost all the oldest messages on a queue are expired messages. The following exemplary use case is described to illustrate this problem. In this use case, applications are consuming on average 100 messages per second in a queue of the messaging middleware. The system wants to stay ahead of the application consumption rate, meaning the system should try to keep several seconds worth of messages in memory such that whenever an application issues a “get message” API and a non-expired message resides on that queue, that message is in memory. In this example, the system wants to read 5 seconds worth of messages into memory (i.e., 500 messages in this example) where each message requires a single I/O to read the message from disk storage into memory. If the first 500 messages on queue are valid (i.e., not expired), then system recovery would have to perform 500 I/Os to the disk storage to retrieve the 500 messages. However, if instead 9,500 of the oldest 10,000 messages on this queue are expired, it would take 10,000 I/Os to the disk storage find the oldest 500 messages on this queue that are still valid. That overhead and delay would increase the system outage time. Depending on rates at which messages are created (e.g., via a “put message” API) and consumed (e.g., via a “get message” API), scanning every message on queue often enough to delete enough expired messages before a system outage may not be possible, thereby causing delays in system recovery. The problem gets worse as message volumes and message sizes increase.

Under normal conditions, messages are sent to the receiving node and acknowledged soon after they are sent, meaning there are not many messages on a queue saved in memory or on disk storage at a single point of time. As long as the number of messages saved on disk storage is small, inefficiencies recovering from an outage can be tolerated. However, if the number of messages saved on disk storage becomes large, then inefficiencies in rebuilding queues can cause problems when there are a large number of expired messages toward the front of the queue. For example, on some large systems the availability of certain real-time applications is critical. Downtime is measured in lost revenue. The more messages on disk storage that will need to be read, meaning the more I/Os that will need to be done, the longer the delay for the availability of critical real-time applications as the system recovery time will be longer. Such a large volume of messages on disk can occur when messages on the sending node are created faster than they are acknowledged from the receiving node. For example, the receiving node may have an outage or there may be network issues between the nodes. In such cases, message queues can grow very large for such stalled queues which in turn means the amount of disk storage used to hold those stalled messages can also grow very large. However, when a queue stall is followed by a system outage, during the system recovery many messages may need to be read from disk storage to reconstruct the queues at a single point of time. Such a large number of read I/Os could cause a hardship on a system. As application message volume has trended higher and messages have increased in size, this problem has grown and continues to grow.

Implementations of the invention address these problems by providing a method to dynamically save expiration time information for messages in a file associated with a group of plural messages and using such information to facilitate more efficient processing of expired messages on queueing middleware, thereby allowing for better queue recovery following a system outage and less impact to applications when many messages on a queue expire in a short period of time. In contrast to current solutions used in message queuing middleware, implementations provide for saving expired message information for every individual message as well as groups of messages. In one example, expiration for a group of messages is defined as the last expired time for all messages within the group. Efficiencies are realized when removing expired messages from memory and persistent storage media, such as disk storage, and recovering messages following an outage.

Implementations of the invention provide the advantage of proactively deleting expired messages from memory and disk storage for large queues, especially during queue stalls (which may be defined as a situation in which messages are not being read by the receiving system such that the queue may stay large and even continue to grow). Saving disk space can be important to a system with a growing queue that is not being processed. To allow a queue of persistent messages to continue to grow, enough disk space should be available to outlast a queue stall.

Implementations of the invention provide the advantage of removing messages from disk storage efficiently. In one example, if N number of messages are saved in disk storage, embodiments improve system performance by performing much less than N number of I/Os to the disk storage to determine which messages have expired and can therefore be deleted from the disk storage.

Implementations of the invention provide the advantage of minimizing queue recovery time following a system outage. In one example, if a system takes an outage, especially during a queue stall, embodiments minimize queue recovery time after the outage by drastically reducing the number of I/Os to the disk storage by eliminating the need to perform such I/Os for expired messages. This permits the system to skip I/Os that would otherwise be performed for expired messages when recovering the non-expired messages, thereby allowing critical real-time applications to become available sooner.

In accordance with aspects of the invention, a method used to provide these and other advantages includes grouping multiple messages stored in the disk storage into a bundle and creating a new file, referred to herein as a bundle control file, containing expiration time information about each message in the bundle. In embodiments, the bundle control file for a bundle includes respective expiration times associated with the respective ones of the messages in the bundle, and a last expiration time that equals a latest one of the respective expiration times of the messages in the bundle. A bundle as described herein is a logical grouping of plural ones of the messages that are stored in the disk storage. Such a bundle may include a grouping of ones of the messages stored on the disk storage in the order in which the messages were created. In embodiments, the maximum number of messages included in a bundle is a parameter that a user may define, e.g., via user input via a user interface of the messaging middleware.

The following exemplary use case is described to illustrate a bundle. In this use case, each bundle may contain up to a maximum of 500 messages of the N number of messages stored in disk storage. In this example, N=1200 such that there are 1200 messages stored in the disk storage. In this example, messages 1 through 501 would be in bundle 1, messages 501 through 1000 would be in bundle 2, and messages 1001 through 1200 would be in bundle 3.

In accordance with aspects of the invention, based on the messaging middleware detecting that a queue has exceeded a certain size in terms of number of messages on that queue, the messaging middleware searches the bundle control files of bundles associated with that queue to determine whether all messages in a respective bundle can be removed from disk storage using information about when the last remaining message in that respective bundle is set to expire. This detection may be performed using periodic checks of the size of a queue (e.g., the number of messages in the queue). If any of these messages also exist in memory, they can also be removed from memory. Using this technique, only one I/O to the disk storage and one check is performed to determine whether an entire bundle of messages can be deleted. Since much fewer I/Os to the disk storage take place to scan all the bundle control files relating to messages on a queue (compared to performing a respective I/O for each respective messages stored in the disk storage), such a utility can be run more often (e.g., seconds) rather than other expired message utilities that scan every message and therefore run less often (e.g., minutes). If at least some of the messages in a given bundle are still valid (i.e., not expired), then the bundle control file for that bundle allows the system to identify which, if any, messages in that bundle have expired to know which messages to clean up (e.g., remove) without any additional I/O required. In this manner, by running such a utility to periodically remove expired messages from the disk storage, embodiments reduce the number of messages stored in disk storage for a queue, which reduces processing time and provides for a faster return to a normal operating state when recovering from a system outage. In embodiments, for messages still on queue, messages in a particular bundle need not be read from disk storage into memory when recovering from a system outage if all messages in the bundle have expired, as determined in embodiments using the latest expiration time information written in the bundle control file of the particular bundle. By determining that all the messages in a bundle are expired based on the latest expiration time information written in the bundle control file of the bundle, implementations reduce the number of I/Os to disk storage when recovering from a system outage (e.g., by performing only a single I/O for the bundle control file instead of performing a respective I/O for each respective messages in the bundle). This reduction of the number of I/Os performed during recovery from a system outage reduces the time required to complete the recovery from the system outage, which is advantageous, in particular for real-time applications in which the reduction of down-time is of the utmost importance.

Embodiments are configured such that different ones of the messages on a queue and stored in the disk storage may have different expiration times. For example, messages on a queue may contain sets of messages that all have a similar expiration time, differing expirations times, or even no expiration times. This differs from solutions that statically allow setting a same expiration time for all messages of a pre-defined group. Although setting a static expiration time for all messages in a group may be useful in some situations, embodiments provide advantages over such solutions by dynamically allowing the saving of expiration times associated with every message at run-time and then further saving expiration times for groups of messages that potentially have unrelated expiration times. This difference provides for a wider reaching solution to save diskspace and minimize I/O times during message queue stalls and recovery from system outages.

Implementations of the invention are necessarily rooted in computer technology. For example, operations performed by message-oriented middleware are necessarily performed by a computer since message-oriented middleware by definition comprises middleware that resides between different layers of a distributed computing system.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as message handling code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

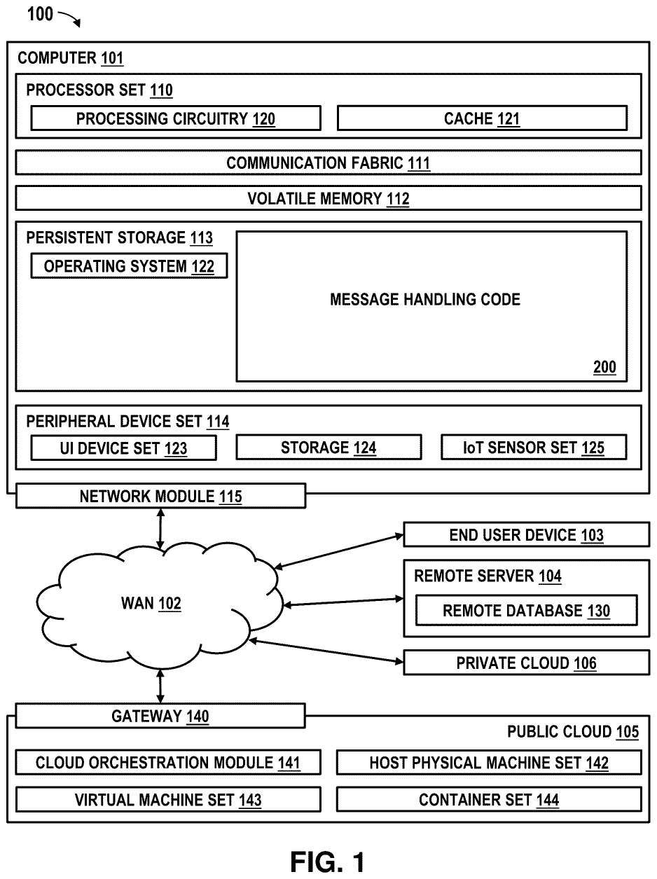

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

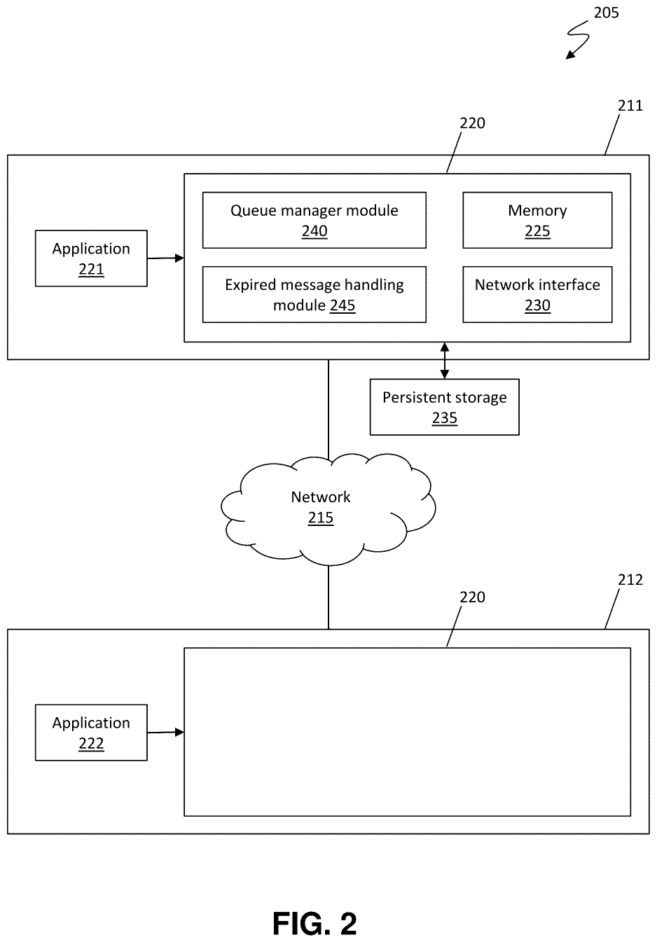

FIG. 2 shows a block diagram of an exemplary environment 205 in accordance with aspects of the invention. In embodiments, the environment 205 includes a first node 211 and a second node 212 in a networked computing environment such as a distributed computing system. Each of the nodes 211 and 212 may comprise or reside on a computing device. In one example, each of the nodes 211 and 212 comprises an instance of the computer 101 of FIG. 1. In another example, each of the nodes 211 and 212 comprises one or more virtual machines or one or more containers running on one or more instances of the computer 101 of FIG. 1. In embodiments, the nodes 211 and 212 communicate with one another via a network 215, which may be the WAN 102 of FIG. 1.

In embodiments, each of the nodes 211 and 212 includes an instance of messaging middleware 220 (also called messaging middleware or MOM) and at least one application, e.g., application 221 on node 211 and application 222 on node 212. The applications 221 and 222 communicate with each other by sending each other data in messages via the messaging middleware 220 rather than by calling each other directly. In embodiments, the applications 221 and 222 communicate with the messaging middleware 220 using messaging APIs.

Although only shown at node 211, in embodiments each of the instances of messaging middleware 220 includes memory 225, a network interface 230, and persistent storage 235. The memory 225 comprises memory such as volatile memory 112 of FIG. 1. The network interface 230 comprises software and/or hardware for facilitating communications via the network 215, such as software for packetizing and/or de-packetizing data for communication via network transmission. The persistent storage 235 of FIG. 2 may be internal to or external from the node 211 and may comprise one or more instances of the persistent storage 113 of FIG. 1. In one example, the persistent storage 235 comprises non-volatile disk storage.

In embodiments, and with continued reference to FIG. 2, each of the instances of messaging middleware 220 comprises a queue manager module 240 and an expired message handling module 245, each of which may comprise one or more modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The messaging middleware 220 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

Functions of the queue manager module 240 and the expired message handling module 245 are described herein for illustration with reference to the application 221 of the node 211 sending messages to the application 222 of the node 212. However, such operations can also be performed in the reverse direction, e.g., the application 222 of the node 212 sending messages to the application 221 of the node 211. In the example described herein, the application 221 sends a message to the application 222 by using a “put message” API call to the messaging middleware 220.

In accordance with aspects of the invention, the queue manager module 240 is configured to manage a message queueing function of the messaging middleware 220. In embodiments, the queue manager module 240 stores, in the persistent storage 235, a copy of each message sent by the application 221 to the application 222. In embodiments, and for performance reasons (i.e., to increase the speed of handling messages), the queue manager module 240 also stores “M” number of the same messages in the memory 225. During operation of the messaging system, the queue manager module 240 removes a respective message from the persistent storage 235 (and from the memory 225 if stored there) based on receiving an indication (e.g., acknowledgement) from the node 212 that the respective message was received by the node 212. In various embodiments, in the event of a system failure, the queue manager module 240 is configured to retrieve messages from the persistent storage 235 and continue attempting to deliver the messages to the node 212 until such time as the node 212 acknowledges receipt of the messages. A system failure in this context may include but is not limited to a failure of the node 211, a failure of the node 212, or a failure of the network 215.

In accordance with aspects of the invention, the expired message handling module 245 is configured to perform operations used to determine when a message, or group of messages, stored in the persistent storage 235 is expired. In embodiments, the expired message handling module 245 is configured to define a bundle that includes a group of messages stored in the persistent storage 235 and create a bundle control file associated with the bundle. In embodiments, the bundle control file comprises: respective pointers associated with respective ones of the messages in the bundle; respective expiration times associated with the respective ones of the messages in the bundle; and a last expiration time that equals a latest one of the respective expiration times.

In one exemplary operation, the expired message handling module 245 is configured to remove (e.g., delete) expired messages from the persistent storage 235 based on information in the bundle control file. In this operation, the expired message handling module 245 performs an I/O to the persistent storage 235 to obtain the bundle control file associated with a bundle. The expired message handling module 245 then determines the expiration time of one or more messages in this bundle based on the expiration time information in the bundle control file. In this operation, the expired message handling module 245 removes from the persistent storage 235 messages that are determined to be expired based on the expiration time information in the bundle control file. In this operation, if the last expiration time indicated in a bundle has passed (e.g., if the current time is after the last expiration time), then every message in the bundle may be removed from the persistent storage 235 without looking at each respective expiration time in the bundle control file. In this operation, if the last expiration time indicated in a bundle has not passed (e.g., if the current time is not after the last expiration time), then respective ones of the messages in the bundle may be removed from the persistent storage 235 based on their respective expiration times in the bundle control file. In various embodiments, for a respective bundle, this operation comprises only a single I/O to the persistent storage 235 (i.e., to read the bundle control file associated with this bundle) in order to determine an expiration time for all the messages in the bundle, rather than performing a respective I/O to the persistent storage 235 to determine the expiration time of each respective one of the messages in the bundle. This operation may be performed periodically, e.g., as a utility, to dynamically maintain the messages stored in the persistent storage 235.

In another exemplary operation, the expired message handling module 245 is configured to use information in the bundle control file to identify expired messages stored in the persistent storage 235 when reading messages from the persistent storage 235 to the memory 225, e.g., during a recovery from a system outage. In this operation, the expired message handling module 245 performs an I/O to the persistent storage 235 to obtain the bundle control file associated with a bundle. The expired message handling module 245 then determines the expiration time of one or more messages in this bundle based on the expiration time information in the bundle control file. In this operation, messages that are determined to be non-expired are read from the persistent storage 235 to the memory 225, and messages that are determined to be expired are removed (e.g., deleted from) the persistent storage 235 and not read to the memory 225. In this operation, if the last expiration time indicated in a bundle has passed (e.g., if the current time is after the last expiration time), then every message in the bundle is expired, and none of the messages are read into the memory 225. In this operation, if the last expiration time indicated in a bundle has not passed (e.g., if the current time is not after the last expiration time), then respective ones of the messages in the bundle may be read from the persistent storage 235 to the memory 225 based on their respective expiration times in the bundle control file. In various embodiments, for a respective bundle, this operation comprises only a single I/O to the persistent storage 235 (i.e., to read the bundle control file associated with this bundle) in order to determine an expiration time for all the messages in the bundle, rather than performing a respective I/O to the persistent storage 235 to determine the expiration time of each respective one of the messages in the bundle. This operation may be performed on an as needed basis, e.g., as part of a recovery from a system outage.

The following example is described to illustrate aspects of the invention and advantages that embodiments of the invention provide over other message queuing middleware systems. In this example, the sending application on the sending node is creating 50 messages per second, all of which are placed on queue and each of which has an expiration time of one minute. In this example, in other systems, the messages are not proactively removed from the disk storage and standard sequential message chaining is used in the disk storage, meaning that the queue control record points to message 1, message 1 points to message 2, message 2 point to message 3, and so on. During normal operation (e.g., non-stall operation), messages are being sent to the receiving node and being added to the queue in disk storage in the sending node. During normal operation, the receiving node acknowledges a message soon after it is sent by the sending node and, in response to this acknowledgement, the message is removed from the queue in the disk storage. In this situation, at any given point in time for a normal moving queue, there are very few messages that exist in the queue in memory or disk storage on the sending node. This is because during normal operation all messages are being consumed well before their expiration time, meaning there are no expired messages in the queue.

Continuing this example, a stalled queue occurs when the sending node is not receiving message acknowledgements from the receiving node. This may be the case, for example, when the sending node is able to receive messages from the sending application, but the sending node has a network problem and is not able to send the messages to the receiving node. In this example with a message creation rate of 50 messages per second by the sending application, approximately 3000 new messages are created and written to the disk storage of the sending node in a one-minute interval. After an hour in this stalled queue situation, the number of messages created and written to the disk storage of the sending node is 180,000. As noted previously in this example, each of the messages has an expiration time of one minute. This means that 177,000 of the 180,000 messages stored on the disk storage of the sending node are expired. In this example, when the network problem is resolved and the sending node is again able to send messages to the receiving node, the sending node will attempt to send queued messages to the receiving node. For message queuing middleware systems that do not proactively delete expired messages from disk storage, the sending node performs a respective I/O to the disk storage for each respective one of the messages stored in the disk storage in order to determine the expiration time of the respective message. After performing a respective I/O to read a respective message from the disk storage, the sending node either sends the message if it is not expired or does not send the message if it is expired. In this example, for message queuing middleware systems that do not proactively delete expired messages from disk storage, the sending node performs 177,000 I/Os to the disk storage before it finds the first non-expired message in the disk storage. This is a large number of I/Os to perform for messages that are not sent to the receiving node because they have already expired. Thus, maintaining expired messages in the disk storage creates a problem both in terms of disk space (e.g., volume in the disk storage to store 177,000 expired messages that aren't sent) and system speed (e.g., time spent performing 177,000 I/Os on messages that aren't sent, which slows system response time for messages that are sent).

In a variation of this example, other message queuing middleware systems may be configured to remove all expired messages once every 5 minutes. Continuing the example from above, when all the messages on the queue have the same expiration time of 1 minute, then in this variation the queue will hold at most 5 minutes of expired messages on the disk storage. After one hour of a queue stall such as that described above, the queue in this example will include 5 minutes of expired messages and 1 minute of unexpired messages, meaning that 18,000 messages are stored in the disk storage. This variation helps alleviate the problem of disk storage by removing (e.g., deleting from the disk storage) expired messages once every 5 minutes. However, this variation does not alleviate the problem of number of I/Os needed to identify the expired messages. This is because in this example 162,000 I/Os are performed every 5 minutes during the queue stall in order to identify and delete expired messages from the queue. In this example, if the sending node suffers a failure, then a flurry of I/Os will need to take place during system recovery to bring back to memory the needed number of messages, given the rate messages are being consumed, for a queue of 18,000 messages where 15,000 messages, presumably in the front of the queue, have expired. Moreover, if messages on a queue have different expiration times, for example 20,000 messages are created all of which expire at noon, then in one second the queue can go from there being no expired messages to having 20,000 expired messages. Therefore, systems that remove all expired messages using a static predefined time interval do not solve all the problems described herein.

Implementations of the invention provide a solution to these problems by performing a more efficient way of removing expired messages from queue requiring less I/Os. By removing expired messages from a queue in a more efficient manner, implementations may be run more often (e.g., periodically in units of seconds rather than minutes), which results in less messages left on queue and therefore more efficient usage of recovery logs. In addition, when queues are reconstructed after a system outage, embodiments facilitate rebuilding queues by executing many less I/Os as compared to other message queuing middleware systems.

In embodiments, the expired message handling module 245 bundles messages on disk storage (e.g., in persistent storage 235) and creates a novel bundle control file that contains the expiration time of every message in the bundle and the last (i.e., latest in time) expiration time of all the messages in the bundle. In embodiments, the expired message handling module 245 reads only the bundle control file from the persistent storage 235 to determine whether some or all of the messages in the bundle can be deleted.

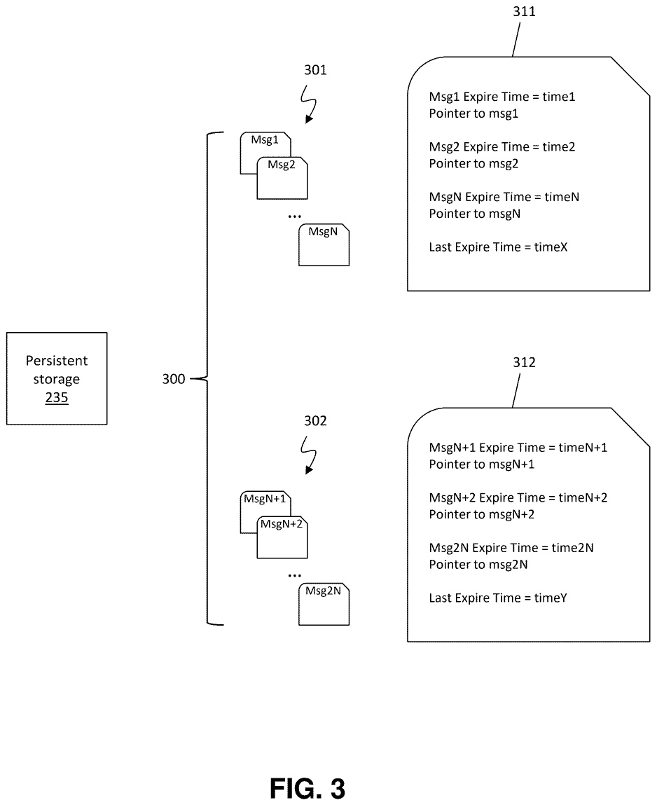

FIG. 3 shows an example of a bundle and a bundle control file in accordance with aspects of the present invention. In FIG. 3, plural messages 300 are stored in persistent storage 235. In this example, the persistent storage 235 is associated with the node 211 of FIG. 2, and the messages 300 are stored in the persistent storage 235 as being in a queue of the messaging middleware 220 while the sending node 211 awaits acknowledgment of the messages 300 from the receiving node 212. In this example, each respective one of the messages 300 has its own respective expiration time that is independent of the expiration times of the other ones of the messages 300. For example, the expiration time of one of the messages 300 may be the same as the expiration time of another one of the messages 300 or may be different than the expiration times of other ones of the messages. The expiration times may have any value including non-zero values or a zero (or null) value which indicates that a message never expires.

In accordance with aspects of the invention, the expired message handling module 245 of the sending node 211 of FIG. 2 defines bundles 301 and 302 that include respective groups of the messages 300. In this example, each of the bundles 301 and 302 includes “N” number of the messages 300, where N is a parameter that may be a default of the system and/or may be defined by user input, e.g., via a user interface of the messaging middleware 220. In embodiments, the bundles may be defined by grouping messages in the order that the messages were saved to the persistent storage 235. Although two bundles are shown, more than two bundles may be created when the number of messages 300 exceeds 2N.

In accordance with aspects of the invention, the expired message handling module 245 creates a respective bundle control file 311 and 312 for each of the respective bundles 301 and 302. In embodiments, the bundle control file associated with a bundle includes: respective pointers associated with respective ones of the messages in the bundle; respective expiration times associated with the respective ones of the messages in the bundle; and a last expiration time that equals a latest one of the respective expiration times. In the example shown in FIG. 3, the bundle control file 311 includes respective pointers (e.g., Pointer to msg1, Pointer to msg12, . . . , Pointer to msgN) associated with respective ones of the messages (e.g., Msg1, Msg2, . . . , MsgN) in the bundle 301. Each pointer may include data (e.g., metadata) that defines where a message is stored in the persistent storage 235 (e.g., a logical address in a disk drive). In the example shown in FIG. 3, the bundle control file 311 includes respective expiration times (e.g., Msg1 Expire Time=time1, Msg2 Expire Time=time2, . . . , MsgN Expire Time=timeN) associated with respective ones of the messages (e.g., Msg1, Msg2, . . . , MsgN) in the bundle 301. In the example shown in FIG. 3, the bundle control file 311 includes a last expiration time (e.g., Last Expire Time=timeX) that equals a latest one of the respective expiration times (e.g., time1 through timeN) of the bundle 301. A respective expiration time may comprise a timestamp of a time the respective message expires. Bundle control file 312 may have similar information associated with the messages in the bundle 302.

In embodiments, the expired message handling module 245 saves the bundle control files 311 and 312 in the persistent storage 235. In this manner, the expired message handling module 245 may read perform a single I/O to the persistent storage 235 to read the bundle control file 311, and may use the information contained in the bundle control file 311 to determine the expiration time of all the messages included in the bundle 301. In an example where the number N equals 500, then the expired message handling module 245 may determine the respective expiration times of 500 different messages by performing only a single I/O to the persistent storage 235 (i.e., the single I/O being performed to read the bundle control file 311) rather than performing 500 I/Os to the persistent storage 235 (i.e., one I/O for each message in the bundle). This facilitates a vast savings in the amount of I/Os performed when determining the expiration times of messages stored in the persistent storage 235.

In embodiments and with continued reference to FIG. 3, the expired message handling module 245 creates a new bundle control file or updates an existing bundle control file in response to the queue manager module 240 saving a new message to the persistent storage 235. In an example of updating an existing bundle control file, if an existing bundle includes less than N messages, then the newly saved message may be added to that bundle and the bundle control file associated with that bundle may be updated to include the pointer and expiration time associated with the newly saved message. In embodiments, when a newly saved message is added to an existing bundle, the expired message handling module 245 also updates the last expiration time information in the associated bundle control file if the expiration time associated with the newly saved message is later than the current value of the last expiration time in that bundle control file. In an example of creating a new bundle control file, if all existing bundles are full (e.g., include the maximum number (N) of messages), then a new bundle is created, the newly saved message is added to the new bundle, and a new bundle control file is created to include the pointer and expiration time associated with the newly saved message. In this example, since the newly saved message is the only message in the new bundle control file, the last expiration time information in the bundle control file is set to equal that of the newly saved message.

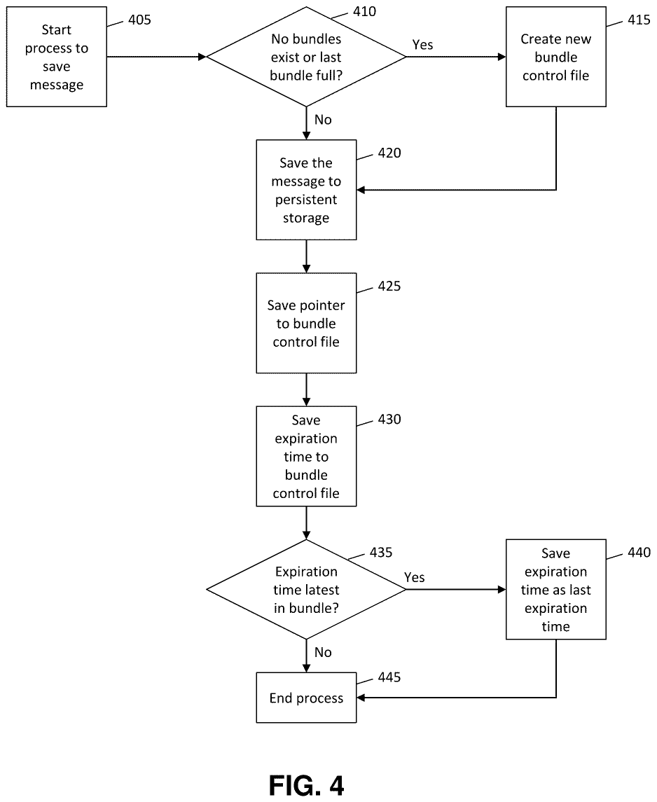

FIG. 4 shows a flowchart 400 of an exemplary method in accordance with aspects of the present invention. Steps of the method (also referred to operations) may be carried out in the environment of FIG. 2 and are described with reference to elements depicted in FIGS. 2 and 3. The flowchart 400 depicts an exemplary method that may be performed to update or create a bundle control file when adding a message to the persistent storage 235 in accordance with aspects of the present invention.

At step 405, the system starts a process to save a new message to the persistent storage 235. In embodiments, the queue manager module 240 starts the process based on the application 221 using an API call to the messaging middleware 220 to send the message to the application 222. In embodiments, the queue manager module 240 adds the message to a queue.

At step 410, the system determines whether no bundles exist for this queue or whether the last bundle for this queue is full. In embodiments, the expired message handling module 245 stores data that defines a list of respective bundle control files associated with the queue. This data may include, for each respective bundle control file associated with the queue, a pointer to the bundle control file that defines where the bundle control file is stored in the persistent storage 235 (e.g., a logical address in a disk drive) and a number of messages included in a bundle associated with the bundle control file. A maximum number of messages in a bundle may be defined as a system parameter.

If at step 410, the system determines that no bundles exist for this queue or the last bundle for this queue is full, then at step 415 the system creates a new bundle control file. In embodiments, the expired message handling module 245 creates the new bundle control file. In embodiments, if the new bundle control file is not the first bundle control file for this queue, then the expired message handling module 245 chains the new bundle control file to a previous bundle control file for this queue. In one example, the bundle control files for a queue are chained to one another sequentially in order of their creation, so that the first bundle control file is chained to the second bundle control file, the second bundle control file is chained to the third bundles control file, and so on. Chaining in this context may comprise using metadata that points from one bundle control file to another bundle control file and that can be used to define an order in which the bundle control files are processed during one or more utilities.

Following step 415, or if at step 410 the system determines that a non-full bundle exists for this queue, then at step 420 the system saves the message (from step 405) in the persistent storage 235. In embodiments, the queue manager module 240 calls a routine that copies the message to the persistent storage 235.

At step 425, the system updates a bundle control file by saving a pointer associated with the message (that was saved at step 420) in the bundle control file. In one example, the expired message handling module 245 saves the pointer in a new bundle control file that was created at step 415. In another example, the expired message handling module 245 saves the pointer in an existing bundle control file that is associated with a non-full bundle determined at step 410. In embodiments, the pointer includes data (e.g., metadata) that defines where the message that was saved at step 420 is stored in the persistent storage 235 (e.g., a logical address in a disk drive).

At step 430, the system updates the same bundle control from step 425 file by saving an expiration time associated with the message (that was saved at step 420) in the bundle control file. In embodiments, the expiration time associated with the message defines an expiration time for the message and may be expressed in terms of a timestamp. The expiration time may have a non-zero value meaning that the message will expire, or it may have a zero (or null) value meaning that the messages will not expire.

At step 435, the system determines whether the expiration time added to the bundle control file at step 430 is the latest expiration time in the bundle control file. In one example in which a new bundle control file was created at step 415, the expiration time added to the bundle control file at step 430 is the only expiration time in the bundle control file, and the process proceeds to step 440 where the expired message handling module 245 updates the bundle control file by setting the last expiration time for this bundle to the expiration time added to the bundle control file at step 430. In another example in which a non-full bundle was identified at step 410, the expired message handling module 245 compares the expiration time added to the bundle control file at step 430 to the last expiration time already defined in the bundle control file. If the expiration time added to the bundle control file at step 430 is later than the last expiration time already defined in the bundle control file, then the process proceeds to step 440 where the expired message handling module 245 updates the bundle control file by setting the last expiration time for this bundle to the expiration time added to the bundle control file at step 430. If the expiration time added to the bundle control file at step 430 is earlier than the last expiration time already defined in the bundle control file, then the process ends at step 445. An expiration time having a zero (or null) value, meaning that the message will not expire, may be treated as an infinitely large value for this comparison.

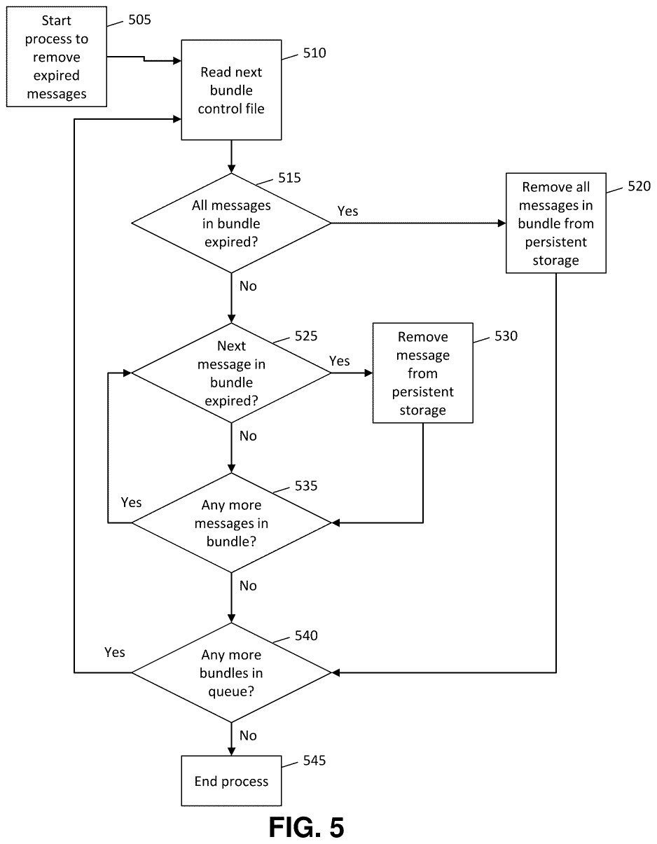

FIG. 5 shows a flowchart 500 of an exemplary method in accordance with aspects of the present invention. Steps of the method (also referred to operations) may be carried out in the environment of FIG. 2 and are described with reference to elements depicted in FIGS. 2 and 3.

The flowchart 500 depicts an exemplary method that may be used to remove messages from the persistent storage 235 based on the expiration time information in a bundle control file in accordance with aspects of the present invention. In various implementations, the method may be performed periodically as a utility to remove expired messages from memory and the persistent storage 235 for a given queue. In embodiments, the method involves reading a bundle control file from the persistent storage 235 and determining which messages in a bundle associated with the bundle control file can be removed from the persistent storage 235, wherein the determining is performed using the expiration time information in the bundle control file.

In one exemplary implementation, the messaging middleware 220 performs the method to run a utility once every “X” number of seconds for a queue that is large, meaning the number of messages in the queue exceeds a user-defined threshold value. The value of X may be defined such that the frequency of running this utility for large queues is often enough to detect and delete expired messages in a much timelier manner when there are potentially thousands of expired messages that need to be cleaned up. A queue with a large number of expired messages at or near the front of the queue has the highest potential for negative impacts to the system and therefore may comprise a condition on which to focus. In this exemplary implementation, the messaging middleware 220 performs the method to run the utility once every “Y” number of minutes for queues that are not large (i.e., the number of messages in the queue is less than the user-defined threshold value) to clean up the likely much smaller number of expired messages. In embodiments, the amount of time represented by X number of seconds is less than the amount of time represented by Y number of minutes.

At step 505, the system starts the utility for a queue of messages stored in the persistent storage 235. In one example, the expired message handling module 245 starts the utility based on determining that the queue includes a number of messages that exceeds a user-defined threshold value and that a timer for running this utility on this queue has reached or exceeded a first predefined time value (e.g., X number of seconds). In another example, the expired message handling module 245 starts the utility based on determining that the queue includes a number of messages that is less than a user-defined threshold value and that a timer for running this utility on this queue has reached or exceeded a second predefined time value (e.g., Y number of minutes).

At step 510, the system reads a next bundle control file from the persistent storage 235. In embodiments, and as described at FIG. 4, the expired message handling module 245 stores data that defines a list of bundle control files associated with the queue. At step 510, the expired message handling module 245 determines a next bundle control file for this queue from the list, for example, by selecting the next bundle control file in the list that has not yet been processed during this iteration of the utility. At the start of the process for a queue, the next bundle control file is the first bundle control file in the list.

At step 515, for the bundle associated with the bundle control file read at step 510, the system determines whether all messages in the bundle are expired. This determination is made using information contained in the bundle control file. In embodiments, the expired message handling module 245 compares a current time (e.g., system time) to the last expiration time (e.g., timestamp) of the bundle control file. If the current time is later than the last expiration time, then the last expiration time has passed, which indicates that all messages in this bundle are expired, and the process proceeds to step 520. If the current time is not later than the last expiration time, then the last expiration time has not passed, which indicates that all messages in this bundle are not expired, and the process proceeds to step 525.

At step 520, for the bundle associated with the bundle control file read at step 510, the system removes all the messages in that bundle from the persistent storage 235. In embodiments, the expired message handling module 245 removes all the messages in this bundle from the persistent storage 235. Removing in this context may comprise freeing up logical addresses of the persistent storage 235 where the messages are stored so that those addresses may be used to store other data. The expired message handling module 245 may call a routine that is configured to perform this operation. At step 520, when removing a bundle, the previous bundle's forward chain is updated to point to the current bundle's (i.e., the forward chain pointer of the one that is being removed).

At step 525, for the bundle associated with the bundle control file read at step 510, the system determines whether a next message in the bundle is expired. This determination is made using information contained in the bundle control file. In embodiments, the expired message handling module 245 determines the expiration time (e.g., timestamp) of the next message in the bundle and compares this expiration time to a current time (e.g., system time). If the current time is later than the expiration time of the message, then the message is expired, and the process proceeds to step 530. If the current time is not later than the expiration time of the message, then the message is not expired, and the process proceeds to step 535.

At step 530, the system removes the message from step 525 from the persistent storage. In embodiments, the expired message handling module 245 removes this particular message from the persistent storage 235 since it was determined at step 525 that this message has expired. Removing in this context may comprise freeing up logical addresses of the persistent storage 235 where the message is stored so that those addresses may be used to store other data. In one example, the expired message handling module 245 calls a routine that is configured to perform this operation. In various embodiments, because the messages are not chained, there is no need to modify any chaining pointers between the messages.

At step 535, the system determines whether there are any more messages in the bundle associated with the bundle control file read at step 510. In embodiments, the expired message handling module 245 makes this determination based on the information contained in the bundle control file. If there are one or more messages remaining in this bundle for which step 525 has not been performed during this iteration of the utility, then the process returns to step 525 to determine the next message in the bundle. If there are not one or more messages remaining in this bundle for which step 525 has not been performed during this iteration of the utility, then the process proceeds to step 540.

At step 540, the system determines whether there are any more bundle control files associated with this queue. In one example, the expired message handling module 245 makes this determination based on the list of bundle control files associated with the queue. In another example, the expired message handling module 245 makes this determination based on this existence of a chaining pointer that points from the bundle control file (previously read at step 510) to another bundle control file. If there are one or more bundle control files for this queue for which step 515 has not been performed during this iteration of the utility, then the process returns to step 510 to read the next bundle control file. If there are no more bundle control files associated with this queue, then the process end at step 545.

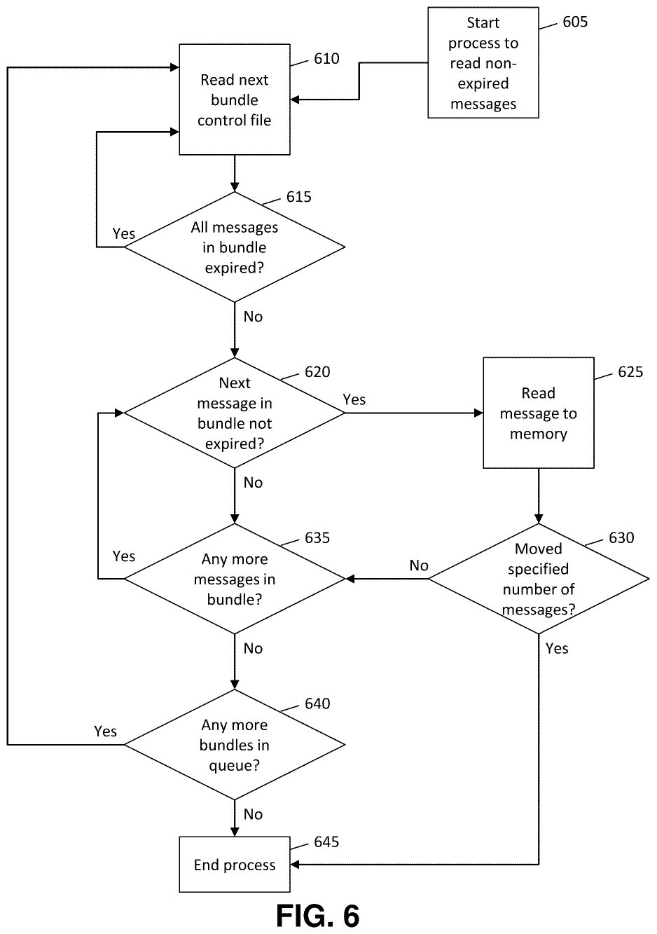

FIG. 6 shows a flowchart 600 of an exemplary method in accordance with aspects of the present invention. Steps of the method (also referred to operations) may be carried out in the environment of FIG. 2 and are described with reference to elements depicted in FIGS. 2 and 3.

The flowchart 600 depicts an exemplary method that may be used to read non-expired messages from the persistent storage 235 to the memory 225 based on the expiration time information in a bundle control file in accordance with aspects of the present invention. In various implementations, the method may be performed on an as-needed basis, e.g., as part of a system recovery process (e.g., system restart) following a system failure or to move more messages into the memory based on the number of messages in the memory falling below a predefined threshold amount.

In various embodiments, during a system restart, the bundle control files are checked prior to reading messages for the queue to determine if any messages in that bundle need to be read. In one example, if the bundle control file indicates all the messages in a bundle have expired, then the system does not read the messages in that bundle from the disk storage into the memory. In another example, if the bundle control file indicates at least some messages in this bundle have not expired, meaning there are valid messages in the bundle, then the individual expiration timestamps are checked to decide which messages to read back from disk storage avoiding I/Os for any expired messages.

At step 605, the system starts the process to move messages from the persistent storage 235 to the memory 225. In embodiments, the queue manager module 240 starts the process as part of a system recovery process (e.g., system restart) following a system failure or to move more messages into the memory based on the number of messages in the memory falling below a predefined threshold amount.

At step 610, the system reads a next bundle control file from the persistent storage 235. This may be performed in the same manner as step 510.

At step 615, for the bundle associated with the bundle control file read at step 615, the system determines whether all messages in the bundle are expired. This may be performed in the same manner as step 515. If all the messages in the bundle are expired, then the process returns to step 610 to read the next bundle control file for this queue. If one or more messages of the bundle are not expired, then the process proceeds to step 620.

At step 620, for the bundle associated with the bundle control file read at step 610, the system determines whether a next message in the bundle is not expired. This determination is made using information contained in the bundle control file, and may be performed in a manner similar to step 525 but with determining whether the message is not expired rather than expired. If the message is not expired, then the process proceeds to step 625. If the message is expired, then the process proceeds to step 635.

At step 625, the system reads the message from step 620 into the memory 225. In embodiments, the queue manager module 240 performs an I/O to the persistent storage 235 to read the message from the persistent storage, and the queue manager module 240 saves that message in the memory 225. Step 625 may additionally include removing the message from the persistent storage 235.

At step 630, the system determines whether a number of messages moved to the memory 225 equals or exceeds a specified number of messages for this iteration of the process. In some embodiments, the process of FIG. 6 is performed as part of a utility to move messages from the persistent storage 235 to the memory 225 based on a number of messages in the memory 225 being below a threshold value. This can occur during normal operation (i.e., not as part of a system restart) when the messaging middleware 220 has consumed the messages in the memory 225 at a rate that causes the number of messages in the memory 225 to fall below the threshold value. In this situation, the queue manager module 240 may specify a number of messages to move from the persistent storage 235 into the memory 225. In embodiments, the expired message handling module 245 keeps a count of messages that are moved from the persistent storage 235 into the memory 225 for each iteration of the process that begins at step 605. At step 630, the count is incremented by one based on moving a message at step 625, and the expired message handling module 245 then compares the count to the specified number of messages for this iteration of the process. If the count is less then the specified number, then the process proceeds to step 635. If the count is equal to or greater than the specified number, then the process ends at step 645.

At step 635, the system determines whether there are any more messages in the bundle associated with the bundle control file read at step 610. This may be performed in the same manner as step 535. If there are no more messages in this bundle to analyze, then the process proceeds to step 640. If there are one or more messages remaining in this bundle to analyze, then the process returns to step 620.

At step 640, the system determines whether there are any more bundle control files associated with this queue. This may be performed in the same manner as step 540. If there are no more bundles in this queue to analyze, then the process ends at step 645. If there are one or more bundles remaining in this queue to analyze, then the process returns to step 610.

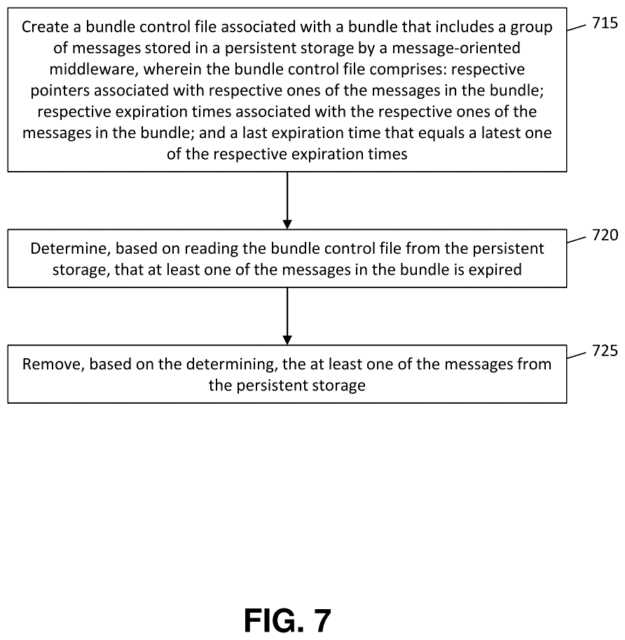

FIG. 7 shows a flowchart 700 of an exemplary method in accordance with aspects of the present invention. Steps of the method (also referred to operations) may be carried out in the environment of FIG. 2 and are described with reference to elements and operations depicted in FIGS. 2-6.

At step 715, the system creates a bundle control file associated with a bundle that includes a group of messages stored in a persistent storage by a message-oriented middleware. In embodiments, the expired message handling module 245 creates a bundle control file such as bundle control file 311 of FIG. 3. In embodiments, the bundle control file comprises: respective pointers associated with respective ones of the messages in the bundle; respective expiration times associated with the respective ones of the messages in the bundle; and a last expiration time that equals a latest one of the respective expiration times. In various embodiments, the expired message handling module 245 saves the bundle control file in the persistent storage 235.

At step 720, the system determines, based on reading the bundle control file from the persistent storage, that at least one of the messages in the bundle is expired. In embodiments, the expired message handling module 245 reads a bundle control file from the persistent storage 235 and determines whether one or more of the messages in the bundle associated with the bundle control file are expired. In one example, this may comprise determining whether all the messages in the bundle are expired based on the last expiration time in the bundle control file, e.g., as at step 515 of FIG. 5. In another example, this may comprise determining whether respective ones of the messages in the bundle are expired based on the respective expiration times in the bundle control file, e.g., as at step 525 of FIG. 5.

At step 725, the system removes, based on the determining at step 720, the at least one of the messages from the persistent storage 235. In one example, the expired message handling module 245 removes all the messages in a bundle from the persistent storage 235, e.g., as at step 520 of FIG. 5. In one example, the expired message handling module 245 removes individual ones of the messages in a bundle from the persistent storage 235, e.g., as at step 530 of FIG. 5.

In embodiments, the method of FIG. 7 additionally includes: storing a new message in the persistent storage; and updating the bundle control file with a new pointer and a new expiration time associated with the new message. This may be performed in the manner described in FIG. 4, for example. The method may additionally include: determining the new message has an expiration time later than the last expiration time; and updating the last expiration time to be equal to the expiration time associated with the new message.

In embodiments, the method of FIG. 7 additionally includes reading one or more of the messages in the bundle from the persistent storage and into a memory of message-oriented middleware. This may be performed in the manner described in FIG. 6, for example. In one example, the reading is performed based on determining the last expiration time has not occurred. In another example, the reading is performed based on the respective expiration times associated with the respective ones of the messages in the bundle.

The following exemplary use case is described to illustrate advantages that may be achieved using various embodiments. In this example, the sending application on the sending node is creating 50 messages per second, all of which are placed on queue and each of which has an expiration time of one minute. In this example, bundles can contain up to 500 messages, and the system checks the queue every 5 seconds for expired messages (e.g., by running a utility in accordance with method of FIG. 5). In this example, 3,250 messages would be saved on disk storage during a queue stall (e.g., because one minute of messages is 3,000 messages plus 5 seconds of expired messages is another 250 messages). In this example, it takes 7 bundles each holding at most 500 messages to hold the 3250 messages. In this example, because all messages have a one-minute expiration, in an hour, 180,000 messages would have been created and 176,750 (180,000-3,250) expired messages would have been deleted during the one-hour stall by running a utility in accordance with method of FIG. 5. Compared to the example case of a queue stall described above in which 18,000 messages remain on disk storage, using implementations of the invention results in 82% less messages stored on disk (e.g., 3,250 vs 18,000) in the best case. Even in cases where messages have varying expiration times, it would be expected during a queue stall to have a large savings being able to determine to delete bundles of messages with a single I/O for a bundle.

Embodiments thus provide efficiencies over current solutions. For example, current solutions search for expired messages every few minutes (e.g., a default value 5 minutes). This is done on order of minutes because it's an exhaustive process that reads every message saved in disk storage. In the example case of a queue stall described above in which 18,000 messages remain on disk storage (e.g., 15,000 for expired messages in 5 minutes plus another 3,000 for non-expired messages), a current solution utility would need to perform 18,000 I/Os in that case. In contrast to that type of approach, implementations of the invention using bundles and bundle control files would perform only 36 I/Os (e.g., 1 I/O per bundle, and 500 messages per bundle) to determine 15,000 messages were expired. That's over a 99% reduction in I/Os provided by implementations of the invention.

Embodiments provide further efficiency over current solutions when chain pointers are taken into account. In current solutions, the messages stored on disk are chained to each other using chain pointers, the use of which requires even more I/Os when a message is deleted in order to update the chain pointers. As described above, embodiments do not utilize chain pointers between the individual messages. Instead, embodiments may utilize chain pointers between ones of the bundle control files, which results in a vastly smaller number of chain pointers, which means that less I/Os are required to update chain pointers when messages are removed. With such drastic efficiencies, running such a utility would cause less stress on a system and therefore can be run more frequently than previous expired message utilities to drastically reduce the likelihood of the problems described herein that are caused by a large number of expired messages on queues. For example, if all queues are proactively searched every minute for expired messages, the worst-case scenario where every bundle had at least one message with no expiration, at most 6,000 messages would be left on queue for the queue stall described above (e.g., 3,000 for one minute of expired messages and 3,000 for one minute of non-expired messages). That's two-thirds less messages on disk (e.g., 6,000 vs 18,000) in the worst case for this example.

In embodiments, scanning large queues every few seconds, especially when queues are stalled, and all queues every minute otherwise, provides two solutions that when combined offer efficiencies in all cases. Embodiments thus improve “get message” API processing time when a system is up and running and there are many messages at the front of the queue, on disk and perhaps also in memory, that have expired. Embodiments also result in a shorter recovery time following a system outage since system restart, trying to read the first N number of messages that are still valid (not expired), will be able to skip all expired messages doing drastically less I/Os since most expired messages have already been deleted from disk and the remaining expired messages can easily be skipped using info in the control files.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
creating a bundle control file associated with a bundle that includes a group of messages stored in a persistent storage by a message-oriented middleware, wherein the bundle control file comprises: respective pointers associated with respective ones of the messages in the bundle; respective expiration times associated with the respective ones of the messages in the bundle; and a last expiration time that equals a latest one of the respective expiration times;
determining, based on reading the bundle control file from the persistent storage, that at least one of the messages in the bundle is expired; and
removing, based on the determining, the at least one of the messages from the persistent storage.

2. The computer-implemented method of claim 1, further comprising:
storing a new message in the persistent storage; and
updating the bundle control file with a new pointer and a new expiration time associated with the new message.

3. The computer-implemented method of claim 2, further comprising:
determining the new message has an expiration time later than the last expiration time; and
updating the last expiration time to be equal to the expiration time associated with the new message.

4. The computer-implemented method of claim 1, wherein the bundle comprises a first bundle and the bundle control file comprises a first bundle control file, and further comprising:
creating a second bundle control file associated with a second bundle that includes a second group of the messages different than the first group of the messages, wherein the second bundle control file comprises: respective pointers associated with respective ones of the messages in the second bundle; respective expiration times associated with the respective ones of the messages in the second bundle; and a second bundle last expiration time that equals a latest one of the respective expiration times of the messages in the second bundle.

5. The computer-implemented method of claim 4, further comprising chaining the second bundle control file to the first bundle control file.

6. The computer-implemented method of claim 1, wherein the determining that at least one of the one of the messages in the bundle is expired comprises determining that all the messages in the bundle are expired based on the last expiration time.

7. The computer-implemented method of claim 1, wherein the determining that at least one of the one of the messages in the bundle is expired comprises:
determining the last expiration time has not occurred; and
determining the at least one of the messages is expired based on the respective expiration times associated with the respective ones of the messages in the bundle.

8. The computer-implemented method of claim 1, further comprising reading one or more of the messages in the bundle from the persistent storage and into a memory of the message-oriented middleware.

9. The computer-implemented method of claim 8, wherein the reading is performed based on determining the last expiration time has not occurred.

10. The computer-implemented method of claim 8, wherein the reading is performed based on the respective expiration times associated with the respective ones of the messages in the bundle.

11. The computer-implemented method of claim 1, wherein:
the messages were sent by a first node to a second node via the message-oriented middleware; and
the storing the messages in the persistent storage is based on the first node having not received indication of receipt of the messages from the second node.

12. The computer-implemented method of claim 1, wherein the determining that the at least one of the messages in the bundle is expired is performed without reading the at least one of the messages from the persistent storage.

13. A computer program product comprising:
one or more computer-readable storage media; and
program instructions stored on the one or more computer-readable storage media to perform operations comprising:
creating a bundle control file associated with a bundle that includes a group of messages stored in a persistent storage by a message-oriented middleware, wherein the bundle control file comprises: respective pointers associated with respective ones of the messages in the bundle; respective expiration times associated with the respective ones of the messages in the bundle; and a last expiration time that equals a latest one of the respective expiration times;
determining, based on reading the bundle control file from the persistent storage, that at least one of the messages in the bundle is expired; and
removing, based on the determining, the at least one of the messages from the persistent storage.

14. The computer program product of claim 13, wherein the operations further comprise:
storing a new message in the persistent storage; and
updating the bundle control file with a new pointer and a new expiration time associated with the new message.

15. The computer program product of claim 13, wherein the operations further comprise reading one or more of the messages in the bundle from the persistent storage and into a memory of the message-oriented middleware, wherein the reading is performed based on determining the last expiration time has not occurred.

16. The computer program product of claim 13, wherein:
the messages were sent by a first node to a second node via the message-oriented middleware; and
the storing the messages in the persistent storage is based on the first node having not received indication of receipt of the messages from the second node.

17. A computer system comprising:
a processor set;
one or more computer-readable storage media; and
program instructions stored on the one or more computer-readable storage media to cause the processor set to perform operations comprising:
creating a bundle control file associated with a bundle that includes a group of messages stored in a persistent storage by a message-oriented middleware, wherein the bundle control file comprises: respective pointers associated with respective ones of the messages in the bundle; respective expiration times associated with the respective ones of the messages in the bundle; and a last expiration time that equals a latest one of the respective expiration times;
determining, based on reading the bundle control file from the persistent storage, that at least one of the messages in the bundle is expired; and
removing, based on the determining, the at least one of the messages from the persistent storage.

18. The computer system of claim 17, wherein the operations further comprise:
storing a new message in the persistent storage; and
updating the bundle control file with a new pointer and a new expiration time associated with the new message.

19. The computer system of claim 17, wherein the operations further comprise reading one or more of the messages in the bundle from the persistent storage and into a memory of the message-oriented middleware, wherein the reading is performed based on determining the last expiration time has not occurred.

20. The computer system of claim 17, wherein:
the messages were sent by a first node to a second node via the message-oriented middleware; and
the storing the messages in the persistent storage is based on the first node having not received indication of receipt of the messages from the second node.
